(19) United States
(12) Patent Application Publication
(10) Pub. No.: US 2009/0006559 A1
(43) Pub. Date: Jan. 1, 2009

(54) Application Message Subscription Tracking In A High Speed, Low Latency Data Communications Environment

(76) Inventors: Kulvir S. Bhogal, Fort Worth, TX (US); John J. Duigenan, Long Island City, NY (US); Kwang S. Kang, Astoria, NY (US); Paul D. Lewis, Round Rock, TX (US); Ravi Ravisankar, Austin, TX (US); John J. Wang, Gaithersburg, MD (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/769,240

(22) Filed: Jun. 27, 2007

(51) Int. Cl. G06F 15/16

(52) U.S. Cl. 709/206

(57) ABSTRACT

Methods, systems, and products are disclosed for application message subscription tracking in a high speed, low latency data communications environment that includes: receiving, by a stream administration server from a subscribing client device, a subscription initiation request, the subscription initiation request specifying a message topic, the message topic specifying application messages for transmission to the subscribing client device from a message transmitting device; brokering, by the stream administration server, establishment of a message stream that provides the application messages for the specified message topic from the message transmitting device to the subscribing client device; and updating, by the stream administration server, a client subscription repository for monitoring application message subscriptions in dependence upon the subscription initiation request.

### BACKGROUND OF THE INVENTION

1. Field of the Invention

The field of the invention is data processing, or, more specifically, methods, systems, and products for application message subscription tracking in a high speed, low latency data communications environment.

2. Description of Related Art

Messaging environments are generally available to provide data communication between message transmitting devices and message receiving devices using messages. A message is a quantity of data that includes one or more data fields and is passed from a message producer installed on a message transmitting device to a message consumer installed on a message receiving device. A message may represent, for example, numeric or textual information, images, encrypted information, and computer program instructions.

A messaging environment may support point-to-point messaging, publish and subscribe messaging, or both. In a point-to-point messaging environment, a message producer may address a message to a single message consumer. In a publish and subscribe messaging environment, a message producer may publish a message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

For further explanation of a messaging environment, FIG. 1 sets forth a block diagram illustrating a typical messaging environment for data communications that includes a message transmitting device (100), a message receiving device (104), and a message administration server (102). The message transmitting device (100) is a computer device having installed upon it a message producer (110), a set of computer program instructions configured for transmitting messages to the message administration server (102) for delivery to a message receiving device. In the example of FIG. 1, the message producer (110) transmits messages to the message administration server (102) on a message stream (106). The message transmitting device (100) may produce the transmitted messages by generating the messages from data of the message transmitting device itself or data received from some other source. The message receiving device (104) is a computer device having installed upon it a message consumer (112), a set of computer program instructions configured for receiving messages from the message administration server (102). In the example of FIG. 1, the message consumer (112) receives the messages from the message administration server (102) on a message stream (108). In the example of FIG. 1, the message stream (106) and the message stream (108) are data communication channels implemented using, for example, the User Datagram Protocol (‘UDP’) and the Internet Protocol (‘IP’).

In either a point-to-point messaging environment or a publish and subscribe messaging environment, the messages transmitted from message transmitting devices to message receiving devices typically pass through the message administration server (102). The message administration server (102) is computer device having installed upon it a message administration module (114), computer program instructions configured for administering the messages transmitted from the message producer (110) to the message consumer (112). Examples of message administration modules may include the IBM WebSphere® MQ, the Open Message Queue from Sun Microsystems, and the OpenJMS from The OpenJMS Group. In a point-to-point messaging environment, the message administration module (114) provides message queuing for the message consumer (112) as the message administration module (114) receives messages addressed to the consumer (112) from various message providers. In a publish and subscribe messaging environment, the message administration module (114) administers the various channels or topics to which message producers publish and message consumers subscribe. In either message environment, the message administration module (114) may also provide security services to ensure that the only messages arriving at the messaging consumer (112) from the message producer (110) are those messages that the message consumer (112) is authorized to receive and that the message producer (110) is authorized to send.

Current messaging environments such as, for example, the one described above with reference to FIG. 1, have certain drawbacks. Messages transmitted to a message administration server from a message transmitting device for delivery to a message receiving device are delayed in the message administration server until the message administration server can process the messages. The message processing that occurs in the message administration server typically increases the overall messaging latency of the messaging environment and decreases the overall speed for transmitting data in the data communications environment. Messaging latency is the time period beginning when the message producer transmits a message and ending when the message consumer receives the message.

In many data communication environments, even slight increases in messaging latency are costly. Consider, for example, a financial market data environment. A financial market data environment is a data processing environment used to communicate information about financial markets and participants in financial markets. In a financial market data environment, a message is commonly referred to as a ‘tick’ and represents financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. In a financial market data environment, a message producer may provide quotes for the purchase or sale of financial securities based on real-time financial market conditions, and a message consumer may buy and sell financial securities based on financial quotes. When a message consumer buys or sells a financial security based on the quoted price provided by the message producer, the ability of a message consumer to obtain the bid or ask in the quote for the financial security is largely influenced by messaging latency in the financial market data environment. The higher the messaging latency, the less likely a buy or sell order generated by the message consumer will execute at or near the price stated in the financial quote. In fact, a highly volatile security may fluctuate in price dramatically over a time period of a few seconds.

Current solutions to reduce messaging latency are to remove the message administration server from the messaging environment. In such current solutions, the message transmitting devices send messages directly to message receiving devices. The drawback to such current solutions is that removing the message administration server reduces the ability to effectively provide administration functionality typically afforded by the message administration server for the messaging environment. In particular, removing the message administration server reduces the ability to effectively provide application message subscription tracking in the messaging environment. As such, readers will appreciate that room for improvement exists in application message subscription tracking in a high speed, low latency data communications environment.

### SUMMARY OF THE INVENTION

Methods, systems, and products are disclosed for application message subscription tracking in a high speed, low latency data communications environment that includes: receiving, by a stream administration server from a subscribing client device, a subscription initiation request, the subscription initiation request specifying a message topic, the message topic specifying application messages for transmission to the subscribing client device from a message transmitting device; brokering, by the stream administration server, establishment of a message stream that provides the application messages for the specified message topic from the message transmitting device to the subscribing client device; and updating, by the stream administration server, a client subscription repository for monitoring application message subscriptions in dependence upon the subscription initiation request.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a typical messaging environment for data communications.

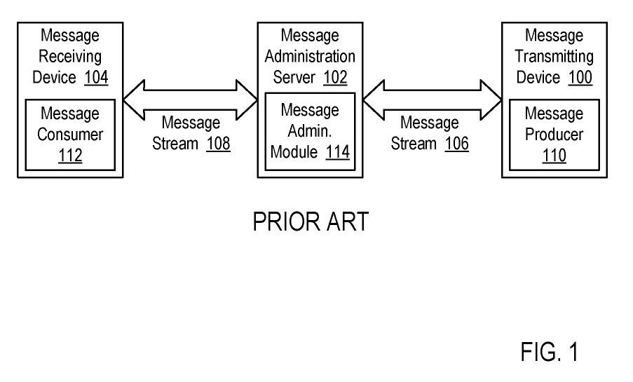

FIG. 2 sets forth a network and block diagram illustrating an exemplary computer data processing system for application message subscription tracking in a high speed, low latency data communications environment according to exemplary embodiments of the present invention.

FIG. 3 sets forth a block diagram of automated computing machinery comprising an exemplary stream administration server useful in application message subscription tracking in a high speed, low latency data communications environment according to exemplary embodiments of the present invention.

FIG. 4 sets forth a flowchart illustrating an exemplary method of application message subscription tracking in a high speed, low latency data communications environment in a high speed, low latency data communications environment according to exemplary embodiments of the present invention.

FIG. 5 sets forth a flowchart illustrating a further exemplary method of application message subscription tracking in a high speed, low latency data communications environment in a high speed, low latency data communications environment according to exemplary embodiments of the present invention.

FIG. 6 sets forth a flowchart illustrating a further exemplary method of application message subscription tracking in a high speed, low latency data communications environment in a high speed, low latency data communications environment according to exemplary embodiments of the present invention.

### DETAILED DESCRIPTION OF EXEMPLARY EMBODIMENTS

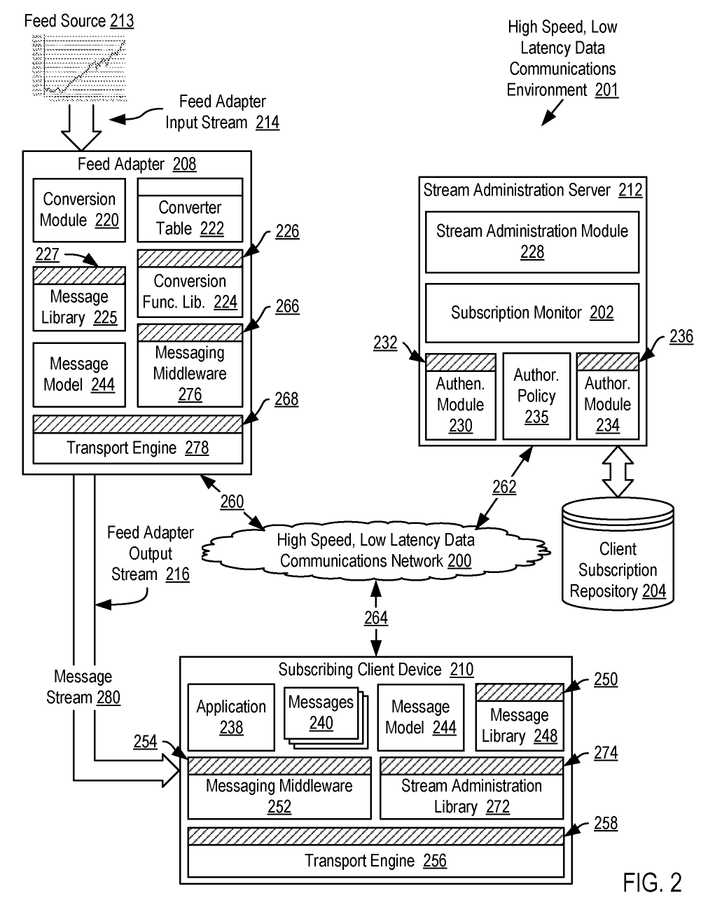

Exemplary methods, systems, and products for application message subscription tracking in a high speed, low latency data communications environment according to embodiments of the present invention are described with reference to the accompanying drawings, beginning with FIG. 2. FIG. 2 sets forth a network and block diagram illustrating an exemplary computer data processing system for application message subscription tracking in a high speed, low latency data communications environment (201) according to embodiments of the present invention. The system of FIG. 2 operates generally for application message subscription tracking in a high speed, low latency data communications environment (201) according to embodiments of the present invention as follows: A stream administration server (212) receives a subscription initiation request from a subscribing client device (210). The subscription initiation request specifies a message topic, which in turn specifies application messages for transmission to the subscribing client device (210) from a message transmitting device. In the example of FIG. 2, the message transmitting device (208) is implemented as a feed adapter. The stream administration server (212) brokers establishment of a message stream (280) that provides the application messages for the specified message topic from the message transmitting device (208) to the subscribing client device (210). The stream administration server (212) then updates a client subscription repository (204) for monitoring application message subscriptions in dependence upon the subscription initiation request.

The high speed, low latency data communications environment (201) illustrated in FIG. 2 includes a high speed, low latency data communications network (200). The high speed, low latency data communications network (200) connects the stream administration server (212), the subscribing client device (210), and the message transmitting device (208) together for data communications by providing the infrastructure for connecting such devices (208, 212, 210). The network (200) of FIG. 2 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 2 may be referred to as a ‘minimally routed network.’ Although the exemplary network (200) illustrated in FIG. 2 does not include a router, such a minimally routed network is for explanation only. In fact, some high speed, low latency networks useful in application message subscription tracking in a high speed, low latency data communications environment according to embodiments of the present invention may include a router.

The high speed, low latency data communications environment (201) depicted in FIG. 2 includes a message stream (280). A message stream is a data communication channel between a communications endpoint of a sending device and a communications endpoint of at least one receiving device. A communications endpoint is typically composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of a single receiving device. A unicast data communication channel may be implemented using, for example, the Transmission Control Protocol (‘TCP’) and IP.

The exemplary system of FIG. 2 includes a stream administration server (212) connected to the high speed, low latency data communications network (200) through a wireline connection (262). The stream administration server (212) of FIG. 2 is a computer device having installed upon it a stream administration module (228), an authentication module (230), an authorization module (234), and an authorization policy (235). A stream administration module (228) is a software component that includes a set of computer program instructions configured for application message subscription tracking in a high speed, low latency data communications environment according to embodiments of the present invention. The stream administration module (228) operates generally for application message subscription tracking in a high speed, low latency data communications environment according to embodiments of the present invention by: receiving, from the subscribing client device (210), a subscription initiation request, the subscription initiation request specifying a message topic that specifies application messages for transmission to the subscribing client device (210) from a message transmitting device (208); brokering establishment of a message stream (280) that provides the application messages for the specified message topic from the message transmitting device to the subscribing client device; and updating a client subscription repository for monitoring application message subs.

To maintain the client subscription repository (204) after the subscribing client device (210) gracefully terminates its application message subscription, the stream administration module (228) may also operate according to embodiments of the present invention by: receiving, from the subscribing client device (210), a subscription termination request that specifies the message topic; and updating the client subscription repository (204) in dependence upon the subscription termination request. Although ideally each subscribing client device (210) while terminate its subscription gracefully, occasionally a subscribing client device abruptly terminates its subscription due to a failure on the subscribing client device such as, for example, a power failure or an unrecoverable processing error that forces the system to reboot. In such a case, the stream administration module (228) may operate for application message subscription tracking according to embodiments of the present invention by: polling the subscribing client device (210) for message topics subscribed to by the subscribing client device (210); and updating the client subscription repository (204) in dependence upon the message topics subscribed to by the subscribing client device (210).

A message topic represents the characteristics of the messages that the subscribing client device (210) requests to receive. Each application message typically includes a topic data field describing the information contained in the application message. Using a message topic, a subscribing client device may specify the group of messages that the subscribing client device (210) requests to receive from the feed adapter (208). In a financial market data environment, for example, a subscribing client device may use a topic to request to receive ticks from an OPRA feed source that contains quotes of an IBM option traded on the Chicago Board Options Exchange (‘CBOE’) that includes the best bid and best ask for the IBM option on the CBOE.

A client subscription repository is a repository that maintains the message topics to which the subscribing client devices in the high speed, low latency data communications network subscribe. In such a manner, the client subscription repository provides the ability to monitor application message subscriptions for subscribing client devices in real-time or provides the ability to historically track application message subscriptions for subscribing client devices. A client subscription repository may be implemented as, for example, a database, an eXtensible Markup Language (‘XML’) document, a text file, or any other repository as will occur to those of skill in the art.

In application message subscription tracking in a high speed, low latency data communications environment according to embodiments of the present invention, the stream administration server (212) may broker establishment of a message stream by authenticating the subscribing client device (210); authorizing the subscribing client device (210) to receive application messages for the message topic specified in the subscription initiation request; and providing the subscribing client device (210) with a data communications endpoint of the message stream (280) for receiving the application messages for the message topic. The authentication may be carried out using the authentication module (230), and the authorization may be carried out using the authorization module (234).

The authentication module (230) of FIG. 2 is a set of computer program instructions capable of providing authentication security services to the stream administration module (228) through an exposed authentication application programming interface (‘API’) (232). Authentication is a process of verifying the identity of an entity. In the exemplary system of FIG. 2, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 2 is a set of computer program instructions capable of providing authorization security services to the stream administration module (228) through an exposed authorization API (236). Authorization is a process of only allowing resources to be used by resource consumers that have been granted authority to use the resources. In the example of FIG. 2, the authorization module (234) identifies the application messages that the subscribing client device (210) is authorized to receive on the message stream (280). The authorization module (234) of FIG. 2 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

The subscription monitor (202) of FIG. 2 is computer software that accesses the message subscription data contained in the client subscription repository (204) for reporting purposes. For example, the subscription monitor (202) may access the client subscription repository (204) and in substantially real-time provide a system administrator with subscription data indicating which message topics are currently being subscribed to by the various subscribing client devices in a particular system. In the example of FIG. 2, readers will note that the subscription monitor (202) is installed on the stream administration server (212). Such an embodiment is for explanation only, and not for limitation. The subscription monitor may be installed on some other device (not shown) that is connected for data communication with client subscription repository (204) through the stream administration server (212), the high speed, low latency network (200), or some other direct or indirect data communications connection with the client subscription repository (204) as will occur to those of skill in the art.

To support the subscription monitor (202) in the example of FIG. 2, the stream administration module (228) accepts processing requests from the subscription monitor (202) to provide application message subscription tracking in a high speed, low latency data communications environment according to embodiments of the present invention. The stream administration module (228) of FIG. 2 provides application message subscription tracking in a high speed, low latency data communications environment according to embodiments of the present invention by: receiving, from the subscription monitor (202), a request for message topics subscribed to by a subscribing client device (210); retrieving results of the request from the client subscription repository (204); and returning the results to the subscription monitor (202).

As mentioned above, the message transmitting device in the example of FIG. 2 is implemented as a feed adapter (208). The feed adapter (208) of FIG. 2 is connected to the high speed, low latency data communications network (200) through a wireline connection (260). The feed adapter (208) is a computer device having the capabilities of converting application messages received on a feed adapter input stream (214) having a first format to application messages having a second format for transmission on a feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 2, the feed adapter (208) receives application messages on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center^{SM} which is an electronic screen-based equity securities market in the United States. In a financial market data environment, a feed adapter input stream is referred to as a ‘financial market data feed.’

The feed adapter (208) of FIG. 2 has installed upon it a conversion module (220), a converter table (222), conversion function library (224), a message library (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 2 is a data structure that specifies the converter functions capable of converting the application message from one format to another format. Utilizing multiple converter tables, the conversion module (220) may convert messages from a variety of input formats to a variety of output formats. In the example of FIG. 2, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 2 may be implemented using a structured document such as, for example, an eXtensible Markup Language (‘XML’) document.

The conversion function library (224) of FIG. 2 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 2, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 2, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). That is, the message model (244) specifies a message format for interpreting application messages and includes one or more field specifications. Each field specification specifies a message field for storing data in an application message and includes field characteristics of the message field. In the example of FIG. 2, the message model (244) is established on both the feed adapter (208) and the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 2, the conversion module (220) and the converter functions of the conversion function library (224) process the data contained in the application messages (240) using the message library (225). The message library (225) is a software module that includes a set of functions for creating, accessing, and manipulating messages (240) according to a message model (244). The message library (225) is accessible to the conversion module (220), the converter functions of the conversion function library (224), and the messaging middleware (276) through a message API (227) exposed by the message library (225).

Before the conversion module (220) of FIG. 2 performs data processing on the application messages, the conversion module (220) receives application messages (not shown) having a first format from the feed source (213). The conversion module (220) of FIG. 2 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 2 performs data processing on the application messages received from the feed source (213), the conversion module (220) provides the application messages having the second format to the messaging middleware (276). The messaging middleware (276) of FIG. 2 is a software component that provides high availability services between the feed adapter (208), any backup feed adapter that may exist, the subscribing client device (210), and the feed source (213). In addition, the messaging middleware (276) of FIG. 2 includes a set of computer program instructions capable of receiving application messages from the conversion module (220) for transmission to the subscribing client device (210), retrieving the contents of each of the application messages, and calculating a hash value for each message in dependence upon the contents of each application message. The hash value provides the ability to rapidly filter in the application messages in the transport layer of the subscribing client device (210). The messaging middleware (276) then provides the received application messages to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 2 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for transmitting the application messages (240) and the hash values to the subscribing client device (210). The messaging middleware (276) operates the transport engine (278) through a transport API (268) exposed by the transport engine (278). The transport engine (278) of FIG. 2 may transmit the application messages (240) and the hash values by prepending each hash value to its corresponding application message, encapsulating the application messages and the hash values provided by the messaging middleware (276) into transport packets, and transmitting the packets through the message stream (280) to the subscribing client device (210).

The subscribing client device (210) in exemplary system of FIG. 2 connects to the high speed, low latency data communications network (200) through a wireline connection (264). The subscribing client device (210) of FIG. 2 is a computer device capable of subscribing to the message streams transmitted by various feed adapters. In a financial market data environment, for example, a subscribing client device may subscribe to a topic to receive the bid and ask prices for a particular security on a message stream provided by a feed adapter controlled by a financial securities broker.

In the example of FIG. 2, the subscribing client device (210) has installed upon it an application (238), a message library (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the message library (248). The message library (248) is software module that includes a set of functions for creating, accessing, and manipulating messages (240) according to the message model (244) that is installed on both the feed adapter (208) and the subscribing client device (210). The message library (248) is accessible to the application (238) through a message API (250) exposed by the message library (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the subscribing client device (210) of FIG. 2 may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) includes a set of computer program instructions for establishing a middleware layer constraint on application messages to be provided to the application (238) of the subscribing client device (210), calculating the transport layer constraint in dependence upon the middleware layer constraint, and providing the transport layer constraint to the transport engine (256) of the subscribing client device (210). The application (238) and the stream administration library (272) interact with the messaging middleware (252) through a messaging middleware API (254).

The transport engine (256) of FIG. 2 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that includes a set of computer program instructions configured for receiving, in the transport engine (256) from the feed adapter (208), application messages (240), determining whether the hash values for the application messages (240) satisfy the transport layer constraint provided by the messaging middleware (252), and administering each of the application messages (240) in dependence upon whether the hash values for the application message (240) satisfy the transport layer constraint.

As mentioned above, the transport engine (256) of FIG. 2 receives both application messages (240) and hash values from the feed adapter (208). The transport engine (256) receives the application messages and the hash values by receiving transport packets through the message stream (280) from the feed adapter (208), and unencapsulating the application messages and the hash values from the received packets. The transport engine (256) of FIG. 2 then provides the application messages (240) to messaging middleware (252) of the subscribing client device (210) if the hash value for each application message (240) satisfies the transport layer constraint. In the example of FIG. 2, the messaging middleware (252) operates the transport engine (256) through a transport API (258) exposed by the transport engine (256).

After the transport engine (256) provides the application messages (240) to messaging middleware (252), the messaging middleware (252) of FIG. 2 further operates to filter the application messages received from the transport engine (256). Readers will recall that a middleware layer constraint on the application messages to be provided to the application (238) is established in the messaging middleware (276) of the subscribing client device (210). Using the middleware layer constraint, the messaging middleware (252) determines whether hash value of the application message satisfies a middleware layer constraint, and administering the application messages (240) in dependence upon whether the hash value of the application message satisfy the middleware layer constraint. Using both the transport layer constraint and the middleware layer constraint, the exemplary system of FIG. 2 advantageously provides the ability to filter application message in both the transport and messaging middleware layers of the network stack based on the contents of the application messages (240).

The servers and other devices illustrated in the exemplary system of FIG. 2 are for explanation, not for limitation. Devices useful in application message subscription tracking in a high speed, low latency data communications environment may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 2 are for explanation, not for limitation. Although the connections to the network (200) of FIG. 2 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 2, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 2.

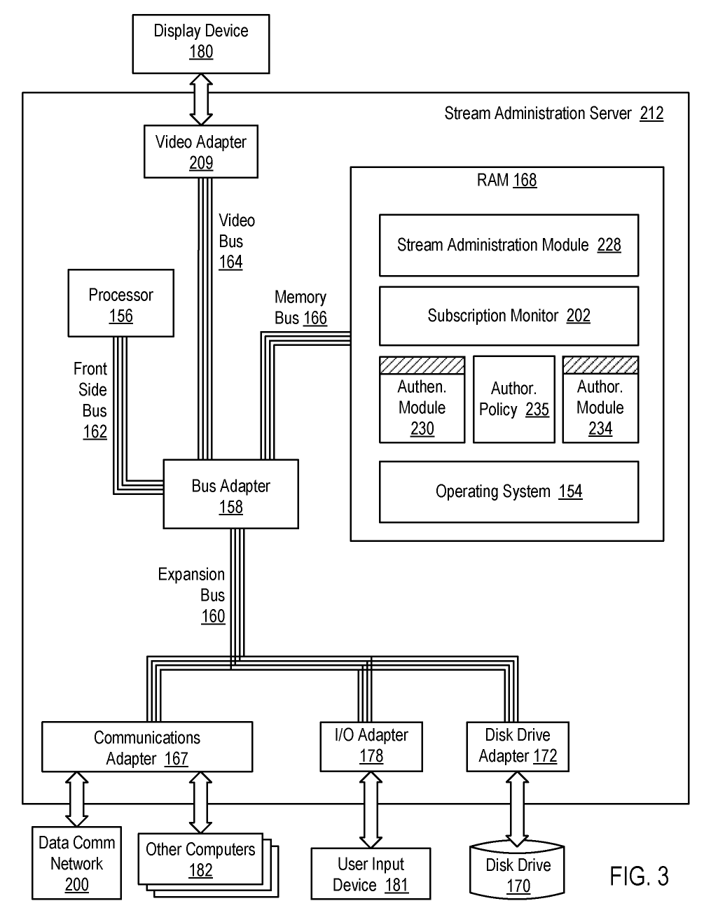

Application message subscription tracking in a high speed, low latency data communications environment in accordance with the present invention may be implemented with one or more stream administration servers, subscribing client devices, and message transmitting devices. These devices and servers are, in turn, implemented to some extent at least as computers, that is, automated computing machinery. For further explanation, therefore, FIG. 3 sets forth a block diagram of automated computing machinery comprising an exemplary stream administration server (212) useful in application message subscription tracking in a high speed, low latency data communications environment according to embodiments of the present invention. The stream administration server (212) of FIG. 3 includes at least one computer processor (156) or ‘CPU’ as well as random access memory (168) (‘RAM’) which is connected through a high speed memory bus (166) and bus adapter (158) to processor (156) and to other components of the stream administration server.

Stored in RAM (168) are a stream administration module (228), a subscription monitor (202), an authentication module (230), an authorization module (234), and an authorization policy (235). The authorization policy (235) of FIG. 3 is a set of rules governing the privileges of authenticated entities to send or receive application messages on a message stream. The stream administration module (228), the subscription monitor (202), the authentication module (230), and the authorization module (234) illustrated in FIG. 3 are software components, that is computer program instructions, that operate as described above with reference to FIG. 2.

Also stored in RAM (168) is an operating system (154). Operating systems useful in stream administration servers according to embodiments of the present invention include UNIX™, Linux™, Microsoft NT™, IBM's AIX™, IBM's i5/OS™, and others as will occur to those of skill in the art. The operating system (154), the stream administration module (228), the subscription monitor (202), the authentication module (230), the authorization module (234), and the authorization policy (235) in the example of FIG. 3 are shown in RAM (168), but many components of such software typically are stored in non-volatile memory also, for example, on a disk drive (170).

The exemplary stream administration server (212) of FIG. 3 includes bus adapter (158), a computer hardware component that contains drive electronics for high speed buses, the front side bus (162), the video bus (164), and the memory bus (166), as well as drive electronics for the slower expansion bus (160). Examples of bus adapters useful in stream administration servers useful according to embodiments of the present invention include the Intel Northbridge, the Intel Memory Controller Hub, the Intel Southbridge, and the Intel I/O Controller Hub. Examples of expansion buses useful in stream administration servers useful according to embodiments of the present invention may include Peripheral Component Interconnect (‘PCI’) buses and PCI Express (‘PCIe’) buses.

The exemplary stream administration server (212) of FIG. 3 also includes disk drive adapter (172) coupled through expansion bus (160) and bus adapter (158) to processor (156) and other components of the exemplary stream administration server (212). Disk drive adapter (172) connects non-volatile data storage to the exemplary stream administration server (212) in the form of disk drive (170). Disk drive adapters useful in stream administration servers include Integrated Drive Electronics (‘IDE’) adapters, Small Computer System Interface (‘SCSI’) adapters, and others as will occur to those of skill in the art. In addition, non-volatile computer memory may be implemented for a stream administration server as an optical disk drive, electrically erasable programmable read-only memory (so-called ‘EEPROM’ or ‘Flash’ memory), RAM drives, and so on, as will occur to those of skill in the art.

The exemplary stream administration server (212) of FIG. 3 includes one or more input/output (‘I/O’) adapters (178). I/O adapters in stream administration servers implement user-oriented input/output through, for example, software drivers and computer hardware for controlling output to display devices such as computer display screens, as well as user input from user input devices (181) such as keyboards and mice. The exemplary stream administration server (212) of FIG. 3 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary stream administration server (212) of FIG. 3 includes a communications adapter (167) for data communications with other computers (182) and for data communications with a high speed, low latency data communications network (200). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for application message subscription tracking in a high speed, low latency data communications environment according to embodiments of the present invention include modems for wired dial-up communications, IEEE 802.3 Ethernet adapters for wired data communications network communications, and IEEE 802.11b adapters for wireless data communications network communications.

Although FIG. 3 is discussed with reference to exemplary stream administration servers, readers will note that automated computing machinery used to implement exemplary subscribing client devices and exemplary message transmitting devices useful in application message subscription tracking in a high speed, low latency data communications environment according to embodiments of the present invention are similar to the exemplary stream administration server (212) of FIG. 3. That is, such exemplary subscribing client devices and message transmitting devices include one or more processors, bus adapters, buses, RAM, video adapters, communications adapters, I/O adapters, disk drive adapters, and other components similar to the exemplary stream administration server (212) of FIG. 3 as will occur to those of skill in the art.

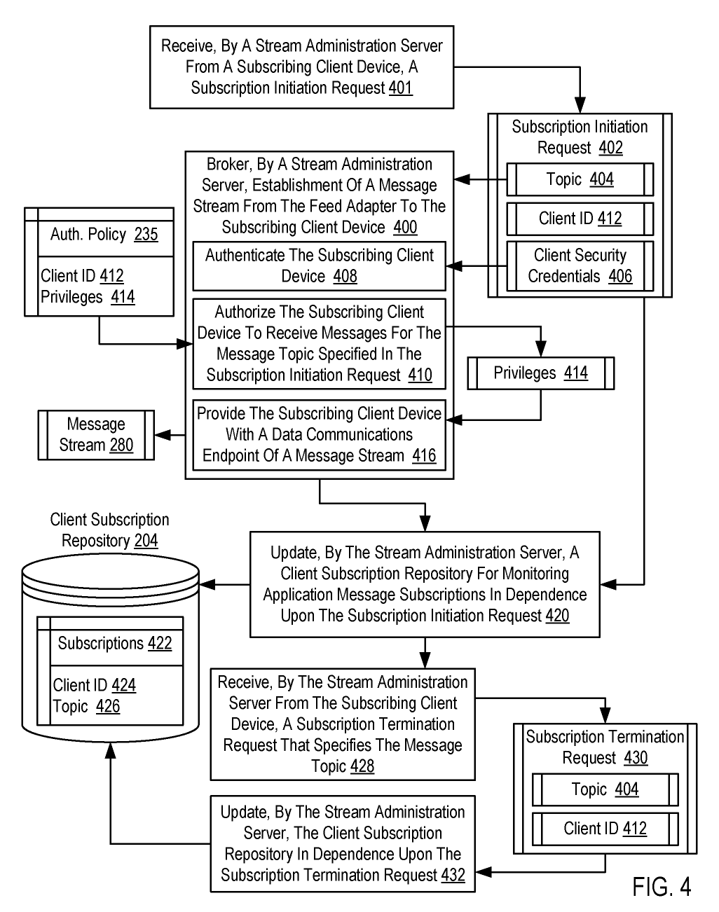

For further explanation, FIG. 4 sets forth a flowchart illustrating an exemplary method of application message subscription tracking in a high speed, low latency data communications environment in a high speed, low latency data communications environment according to embodiments of the present invention. The method of FIG. 4 includes receiving (401), by a stream administration server from a subscribing client device, a subscription initiation request (402). The subscription initiation request (402) is a request by an application of a subscribing client device to receive data from a message transmitting device. The subscription initiation request (402) of FIG. 4 may be implemented as an XML document, a call to a member method of a RMI object on the subscribing client device, or any other implementation as will occur to those of skill in the art.

The subscription initiation request (402) of FIG. 4 specifies a message topic (404), which in turn specifies application messages for transmission to the subscribing client device from a message transmitting device such as, for example, a feed adapter, a message broker, and so on. The message topic (404) specifies application messages for transmission to the subscribing client device because the message topic represents some common characteristics among any number of application messages. By specifying some common characteristics using the message topic (404), the subscribing client device indicates the application messages that the subscribing client device would like to receive. Each application message typically includes a message topic data field describing the information contained in the application message. Using a message topic, a subscribing client device may specify the group of messages that the subscribing client device requests to receive from a message transmitting device. In a financial market data environment, for example, a subscribing client device may use a message topic to request to receive ticks from an OPRA feed source that contains quotes of an IBM option traded on the Chicago Board Options Exchange (‘CBOE’) that includes the best bid and best ask for the IBM option on the CBOE. In addition to specifying the message topic (404), the subscription initiation request also specifies the subscribing client device requesting a subscription using a client identifier (412).

The method of FIG. 4 includes brokering (400), by the stream administration server, establishment of a message stream (280) that provides the application messages for the specified message topic (404) from the message transmitting device to the subscribing client device. The message stream (280) represents a data communication channel between a communications endpoint of a subscribing client device and a communications endpoint of a message transmitting device. A message stream may be implemented as a multicast data communication channel using the UDP/IP protocols or a unicast data communication channel using TCP/IP protocols as discussed above with reference to FIG. 2.

When brokering (400) the establishment of the message stream (280), the stream administration server in the example of FIG. 4 performs several security services to ensure that the subscribing client device only receives messages from the message transmitting device for which the subscribing client device is authorized to receive. In the method of FIG. 4, brokering (400), by the stream administration server, establishment of a message stream (280) is carried out by authenticating (408) the subscribing client device. Authenticating (408) the subscribing client device according to the method of FIG. 4 may be carried out by verifying client security credentials (406) provided by the subscribing client device with the subscription initiation request (402). The client security credentials (406) may be implemented as a digital signature in a public key infrastructure, a security token, or any other security data as will occur to those of skill in the art for authenticating the identity of the originator of the subscription initiation request (402). Examples of security tokens may include those security tokens described in the web services specification entitled ‘Web Services Security’ (‘WS-Security’) developed by IBM, Microsoft, and VeriSign or the web services specification entitled ‘Web Services Trust Language’ (‘WS-Trust’) developed by IBM, Microsoft, Veri Sign, OpenNetworks, Layer 7, Computer Associates, BEA, Oblix, Reactivity, RSA Security, Ping Identity, and Actional.

In the method of FIG. 4, brokering (400), by the stream administration server, establishment of a message stream (280) is also carried out by authorizing (410) the subscribing client device to receive application messages for the message topic (404) specified in the subscription initiation request (402). Authorizing (410) the subscribing client device to receive application messages for the message topic (404) specified in the subscription initiation request (402) according to the method of FIG. 4 may be carried out by identifying the privileges (414) associated with the authenticated subscribing client device in dependence upon an authorization policy (235). The authorization policy (235) is a set of rules governing the privileges of authenticated subscribing client devices requesting to receive data from a message transmitting device. In the example of FIG. 4, the authorization policy (235) associates privileges (414) with a subscribing client device identifier (412). The subscribing client device identifier (412) represents a subscribing client device authenticated by a stream administration server. The privileges (414) represent the set of application messages permissible for an authenticated subscribing client device identified by the associated authenticated subscribing client device identifier (414) to receive from a message transmitting device. Different authenticated subscribing client devices may have different privileges. Although the authorization policy (235) depicted in FIG. 4 associates individual authenticated users with certain privileges, such a depiction is for explanation and not for limitation. The authorization policy (235) may, in fact, grant privileges on the basis of a subscribing client device's membership in a group or on any other basis as will occur to those of skill in the art.

After performing security services, brokering (400), by the stream administration server, establishment of a message stream (280) according to the method of FIG. 4 is carried out by providing (416) the subscribing client device with a data communications endpoint of the message stream (280) for receiving the application messages for the message topic (404). In the example of FIG. 4, the data communication endpoint is a destination address used by the subscribing client device to listen for application messages from the message transmitting device. The destination address may be implemented as a multicast address or a unicast address. Using the destination address provided by the stream administration server, the subscribing client device may establish the message stream (280) from the message transmitting device to the subscribing client device.

The method of FIG. 4 also includes updating (420), by the stream administration server, a client subscription repository (204) for monitoring application message subscriptions in dependence upon the subscription initiation request (402). As mentioned above, the client subscription repository is a repository that maintains the message topics to which the subscribing client devices in the high speed, low latency data communications network subscribe. In such a manner, the client subscription repository provides the ability to monitor application message subscriptions for subscribing client devices in real-time or provides the ability to historically track application message subscriptions for subscribing client devices. The client subscription repository (204) of FIG. 4 may be implemented as, for example, a database, an eXtensible Markup Language (‘XML’) document, a text file, or any other repository as will occur to those of skill in the art.

Updating (420), by the stream administration server, a client subscription repository (204) for monitoring application message subscriptions in dependence upon the subscription initiation request (402) according to the method of FIG. 4 may be carried out by retrieving the values for the message topic (404) and the subscribing client device identifier (412) from the subscription initiation request (402) and associating the retrieved values in a subscription record of the subscriptions table (422) in the client subscription repository (402). The subscription table (422) of FIG. 4 in the client subscription repository (402) is a data structure that stores subscription records. Each subscription record in the subscriptions table (422) associates a subscribing client device identifier (424) with a message topic (426). In such a manner, each subscription record represents a message topic subscribed to by a subscribing client device.

The method of FIG. 4 includes receiving (428), by the stream administration server from the subscribing client device, a subscription termination request (430). The subscription termination request (430) of FIG. 4 is a request by an application of a subscribing client device to no longer receive data from a message transmitting device. The subscription termination request (430) of FIG. 4 may be implemented as an XML document, a call to a member method of a RMI object on the subscribing client device, or any other implementation as will occur to those of skill in the art. In the example of FIG. 4, the subscription termination request (430) specifies the message topic (404) of the application messages that the subscribing client device instructs the stream administration server to no longer provide through the message transmitting device. In addition to specifying the message topic (404), the subscription initiation request also specifies the subscribing client device requesting the message subscription be terminated using a client identifier (412).

The method of FIG. 4 also includes updating (432), by the stream administration server, the client subscription repository (204) in dependence upon the subscription termination request (430). Updating (432), by the stream administration server, the client subscription repository (204) in dependence upon the subscription termination request (430) according to the method of FIG. 4 may be carried out by retrieving the values for the message topic (404) and the subscribing client device identifier (412) from the subscription termination request (430) and deleting the subscription record of the subscriptions table (422) in the client subscription repository (402) that associates the retrieved values. In other embodiments, updating (432), by the stream administration server, the client subscription repository (204) in dependence upon the subscription termination request (430) according to the method of FIG. 4 may be carried out by retrieving the values for the message topic (404) and the subscribing client device identifier (412) from the subscription termination request (430) and flagging the subscription record of the subscriptions table (422) in the client subscription repository (402) that associates the retrieved values as inactive.

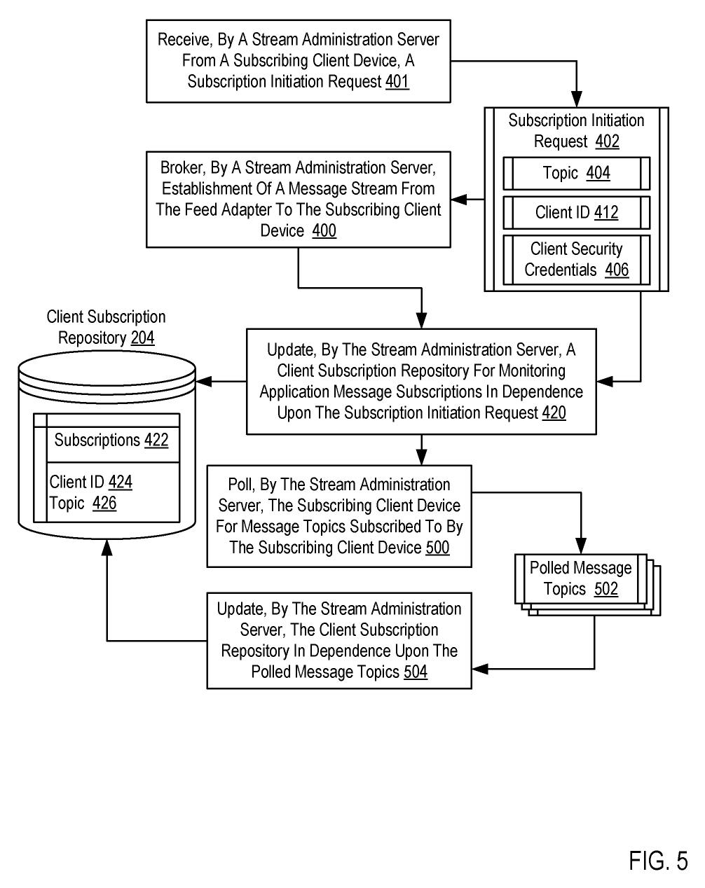

Readers will note that updating (432) the client subscription repository (204) in dependence upon the subscription termination request (430) advantageously maintains accurate records of the application message subscriptions in a data communications environment so long as the subscribing client devices gracefully terminate their subscriptions by providing subscription termination requests. Occasionally, however, a subscribing client device may experience a system failure that prohibits a graceful termination of their application message subscription, such as, for example, a power failure. To maintain accurate records of the application message subscriptions in a data communications environment, a stream administration server may periodically poll the subscribing client devices for the message topics to which the subscribing client devices are subscribed. For further explanation, therefore, FIG. 5 sets forth a flowchart illustrating a further exemplary method of application message subscription tracking in a high speed, low latency data communications environment in a high speed, low latency data communications environment according to embodiments of the present invention that includes polling (500), by the stream administration server, the subscribing client device for message topics (502) subscribed to by the subscribing client device.

The method of FIG. 5 is similar to the method of FIG. 4. That is, the method of FIG. 5 includes: receiving (401), by a stream administration server from a subscribing client device, a subscription initiation request (402), the subscription initiation request (402) specifying a message topic (404), the message topic (404) specifying application messages for transmission to the subscribing client device from a message transmitting device; brokering (400), by the stream administration server, establishment of a message stream (280) that provides the application messages for the specified message topic (404) from the message transmitting device to the subscribing client device; and updating (420), by the stream administration server, a client subscription repository (204) for monitoring application message subscriptions in dependence upon the subscription initiation request (402). The example of FIG. 5 is also similar to the example of FIG. 4 in that the subscription initiation request (402) includes a subscribing client device identifier (412) and client security credentials (406) used to authenticate the subscribing client device.

The method of FIG. 5 differs from the method of FIG. 4 in that the method of FIG. 5 includes polling (500), by the stream administration server, the subscribing client device for message topics (502) subscribed to by the subscribing client device. Polling (500), by the stream administration server, the subscribing client device for message topics (502) subscribed to by the subscribing client device according to the method of FIG. 5 may be carried out by requesting messaging middleware of subscribing client device to provide the current message topics being listened to by the subscribing client device and receiving, in response to the request, message topics (502) from the subscribing client device. The request may be implemented as an XML document, a call to a member method of a RMI object on the stream administration server, or any other implementation as will occur to those of skill in the art. The messaging middleware of the subscribing client device may identify the current message topics being listened to by the subscribing client device by retrieving the message topics (502) from a topic table for the messaging middleware that stores the message topics to which the subscribing client device is currently listening.

The method of FIG. 5 includes updating (504), by the stream administration server, the client subscription repository (204) in dependence upon the polled message topics (502). Updating (504), by the stream administration server, the client subscription repository (204) in dependence upon the polled message topics (502) according to the method of FIG. 4 may be carried out by associating the values for the polled message topics (502) with the identifier (412) for the subscribing client device in subscription records of the subscriptions table (422) in the client subscription repository (402). The subscription table (422) of FIG. 5 in the client subscription repository (402) is a data structure that stores subscription records. Each subscription record in the subscriptions table (422) associates a subscribing client device identifier (424) with a message topic (426). In such a manner, each subscription record represents a message topic subscribed to by a subscribing client device. Readers will note that updating (504), by the stream administration server, the client subscription repository (204) in dependence upon the polled message topics (502) advantageously maintains accurate records of the application message subscriptions in a data communications environment regardless of whether the subscribing client devices abruptly cease listening to application messages due to a system failure.

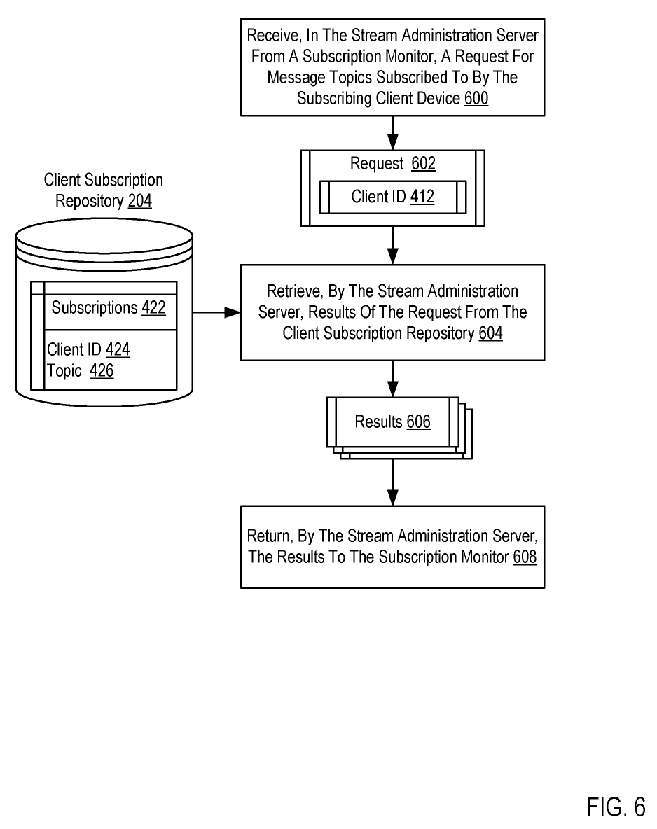

The descriptions above with reference to FIGS. 4 and 5 explain the manner in which a stream administration server may update a client subscription repository according to embodiments of the present invention. After updating the client subscription repository, a subscription monitor may access the message subscription data contained in the client subscription repository for reporting purposes. For example, a subscription monitor may access the client subscription repository (204) to provide in substantially real-time a system administrator with subscription data indicating which message topics are currently being subscribed to by the various subscribing client devices in a particular system. For further explanation, therefore, FIG. 6 sets forth a flowchart illustrating an exemplary method of application message subscription tracking in a high speed, low latency data communications environment in a high speed, low latency data communications environment according to embodiments of the present invention that includes receiving (600), in the stream administration server from a subscription monitor, a request (602) for message topics subscribed to by a subscribing client device.

The request (602) of FIG. 6 for message topics subscribed to by a subscribing client device may specify one or more subscribing client devices. In the example of FIG. 6, the request (602) only specifies one identifier (412), which indicates that the subscription monitor requests all the message topics to which a single subscribing client device identified by identifier (412) is subscribed. The request (602) of FIG. 6 may be implemented as an XML document, a call to a member method of a RMI object on the subscribing client device, a call to a function of an API, or any other implementation as will occur to those of skill in the art. In fact, the request (602) of FIG. 6 may be implemented as a query specified using, for example, the ANSI version of the Structure Query Language (‘SQL’). Implementing the request (602) as a query may provide the subscription monitor with the ability to perform in-depth queries against the client subscription repository (204).

The method of FIG. 6 also includes retrieving (604), by the stream administration server, results (606) of the request from the client subscription repository (204). Retrieving (604), by the stream administration server, results (606) of the request from the client subscription repository (204) according to the method of FIG. 6 may be carried out by retrieving, from the subscriptions table (422) in the client subscription repository (204), subscription records having a value for the client device identifier (424) that matches the value for the client device identifier (412) in the request (602) from the subscription monitor. In the example of FIG. 6, the results (606) of the request (602) may be implemented as the retrieved subscription records from the subscriptions table (422).

The method of FIG. 6 also includes returning (608), by the stream administration server, the results (606) to the subscription monitor. The manner in which the stream administration server returns (608) the results (606) to the subscription monitor may depend on the particular implementation of the request (602). The stream administration server may return (608) the results (606) to the subscription monitor according to the method of FIG. 6 by executing a callback function provided as a parameter of the request (602), executing a function of an API for the subscription monitor, encapsulating the results (606) in an XML document and transmitting the XML document to the subscription monitor via web services, or in any other manner as will occur to those of skill in the art. Readers will note that returning (608) the results (606) to the subscription monitor according to the method of FIG. 6 advantageously allows the subscription monitor to present the results to a system administrator or provide the results to another software application for further processing.

Exemplary embodiments of the present invention are described largely in the context of a fully functional computer system for application message subscription tracking in a high speed, low latency data communications environment. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of application message subscription tracking in a high speed, low latency data communications environment, the method comprising:
receiving, by a stream administration server from a subscribing client device, a subscription initiation request, the subscription initiation request specifying a message topic, the message topic specifying application messages for transmission to the subscribing client device from a message transmitting device;
brokering, by the stream administration server, establishment of a message stream that provides the application messages for the specified message topic from the message transmitting device to the subscribing client device; and
updating, by the stream administration server, a client subscription repository for monitoring application message subscriptions in dependence upon the subscription initiation request.

2. The method of claim 1 further comprising:
receiving, by the stream administration server from the subscribing client device, a subscription termination request that specifies the message topic; and
updating, by the stream administration server, the client subscription repository in dependence upon the subscription termination request.

3. The method of claim 1 further comprising:
polling, by the stream administration server, the subscribing client device for message topics subscribed to by the subscribing client device; and
updating, by the stream administration server, the client subscription repository in dependence upon the polled message topics.

4. The method of claim 1 further comprising:
receiving, in the stream administration server from a subscription monitor, a request for message topics subscribed to by the subscribing client device;
retrieving, by the stream administration server, results of the request from the client subscription repository; and
returning, by the stream administration server, the results to the subscription monitor.

5. The method of claim 1 wherein brokering, by the stream administration server, establishment of a message stream that provides the application messages for the specified message topic from the message transmitting device to the subscribing client device further comprises:
authenticating the subscribing client device;
authorizing the subscribing client device to receive application messages for the message topic specified in the subscription initiation request; and
providing the subscribing client device with a data communications endpoint of the message stream for receiving the application messages for the message topic.

6. The method of claim 1 wherein:
the stream administration server, the subscribing client device, and the message transmitting device are connected for data communications using a high speed, low latency data communications network; and
the message transmitting device is a feed adapter capable of converting application messages received on a feed adapter input stream having a first format to application messages having a second format for transmission on a feed adapter output stream to subscribing client devices.

7. The method of claim 1 wherein the application messages comprises financial market data.

8. A system for application message subscription tracking in a high speed, low latency data communications environment, the system comprising one or more computer processors, computer memory operatively coupled to the one or more computer processors, the computer memory having disposed within it computer program instructions capable of:
receiving, by a stream administration server from a subscribing client device, a subscription initiation request, the subscription initiation request specifying a message topic, the message topic specifying application messages for transmission to the subscribing client device from a message transmitting device;
brokering, by the stream administration server, establishment of a message stream that provides the application messages for the specified message topic from the message transmitting device to the subscribing client device; and
updating, by the stream administration server, a client subscription repository for monitoring application message subscriptions in dependence upon the subscription initiation request.

9. The system of claim 8 wherein the computer memory also has disposed within it computer program instructions capable of:
receiving, by the stream administration server from the subscribing client device, a subscription termination request that specifies the message topic; and
updating, by the stream administration server, the client subscription repository in dependence upon the subscription termination request.

10. The system of claim 8 wherein the computer memory also has disposed within it computer program instructions capable of:
polling, by the stream administration server, the subscribing client device for message topics subscribed to by the subscribing client device; and
updating, by the stream administration server, the client subscription repository in dependence upon the polled message topics.

11. The system of claim 8 wherein the computer memory also has disposed within it computer program instructions capable of:
receiving, in the stream administration server from a subscription monitor, a request for message topics subscribed to by the subscribing client device;
retrieving, by the stream administration server, results of the request from the client subscription repository; and
returning, by the stream administration server, the results to the subscription monitor.

12. The system of claim 8 wherein brokering, by the stream administration server, establishment of a message stream that provides the application messages for the specified message topic from the message transmitting device to the subscribing client device further comprises:
authenticating the subscribing client device;
authorizing the subscribing client device to receive application messages for the message topic specified in the subscription initiation request; and
providing the subscribing client device with a data communications endpoint of the message stream for receiving the application messages for the message topic.

13. The system of claim 8 wherein:
the stream administration server, the subscribing client device, and the message transmitting device are connected for data communications using a high speed, low latency data communications network; and
the message transmitting device is a feed adapter capable of converting application messages received on a feed adapter input stream having a first format to application messages having a second format for transmission on a feed adapter output stream to subscribing client devices.

14. A computer program product for application message subscription tracking in a high speed, low latency data communications environment, the computer program product disposed upon a computer readable medium, the computer program product comprising computer program instructions capable of:
receiving, by a stream administration server from a subscribing client device, a subscription initiation request, the subscription initiation request specifying a message topic, the message topic specifying application messages for transmission to the subscribing client device from a message transmitting device;
brokering, by the stream administration server, establishment of a message stream that provides the application messages for the specified message topic from the message transmitting device to the subscribing client device; and
updating, by the stream administration server, a client subscription repository for monitoring application message subscriptions in dependence upon the subscription initiation request.

15. The computer program product of claim 14 further comprising computer program instructions capable of:
receiving, by the stream administration server from the subscribing client device, a subscription termination request that specifies the message topic; and
updating, by the stream administration server, the client subscription repository in dependence upon the subscription termination request.

16. The computer program product of claim 14 further comprising computer program instructions capable of:
polling, by the stream administration server, the subscribing client device for message topics subscribed to by the subscribing client device; and
updating, by the stream administration server, the client subscription repository in dependence upon the polled message topics.

17. The computer program product of claim 14 further comprising computer program instructions capable of:
receiving, in the stream administration server from a subscription monitor, a request for message topics subscribed to by the subscribing client device;
retrieving, by the stream administration server, results of the request from the client subscription repository; and
returning, by the stream administration server, the results to the subscription monitor.

18. The computer program product of claim 14 wherein brokering, by the stream administration server, establishment of a message stream that provides the application messages for the specified message topic from the message transmitting device to the subscribing client device further comprises:
authenticating the subscribing client device;
authorizing the subscribing client device to receive application messages for the message topic specified in the subscription initiation request; and
providing the subscribing client device with a data communications endpoint of the message stream for receiving the application messages for the message topic.

19. The computer program product of claim 14 wherein:
the stream administration server, the subscribing client device, and the message transmitting device are connected for data communications using a high speed, low latency data communications network; and
the message transmitting device is a feed adapter capable of converting application messages received on a feed adapter input stream having a first format to application messages having a second format for transmission on a feed adapter output stream to subscribing client devices.

20. The computer program product of claim 14 wherein the application messages comprises financial market data.
